(19) United States
(12) Patent Application Publication
(10) Pub. No.: US 2023/0214931 A1
(43) Pub. Date: Jul. 6, 2023

(54) SYSTEMS AND METHODS FOR PREDICTIVE SUPPLEMENTAL CLAIMS AND AUTOMATED PROCESSING

(71) Applicant: Cigna Intellectual Property, Inc., Wilmington, DE (US)

(72) Inventors: Kendie Stroede, Lake Nebagamon, WI (US); Dave Frisch, Denver, CO (US); Ian Roskelley, Parker, CO (US)

(21) Appl. No.: 18/083,295

(22) Filed: Dec. 16, 2022

Related U.S. Application Data
(63) Continuation-in-part of application No. 16/936,488, filed on Jul. 23, 2020, now abandoned.

(51) Int. Cl. G06Q 40/08; G06Q 10/10

(52) U.S. Cl. CPC G06Q 40/08; G06Q 10/10

(57) ABSTRACT

A predictive supplemental claim technology is provided. The technology receives claim records and coverage records. The technology transforms the claim records and the coverage records to use a common data schema from first and second heterogeneous data schemas and extracts a qualifying claim from a first transformed claim record of the transformed claim records. The technology additionally predicts that the qualifying claim results in a supplemental claim by determining that at least one first coverage record of the transformed coverage records specifies that a claimant master record associated with the claimant identifier is entitled to a supplemental claim at the time of the incurred date. The technology is also configured to integrate the first transformed claim record and the at least one first coverage record to identify supplemental claim attributes and define a supplemental claim record based on the supplemental claim attributes.

### FIELD

The field generally relates to systems for computing event prediction, and more specifically to systems for predicting that an event is likely to result in a supplemental insurance claim and automatically processing such claims.

### BACKGROUND

In insurance systems, policy beneficiaries may be entitled to benefits under multiple insurance plans for the same healthcare services or for additional services tied to the same event. For example, many policy holders are eligible for coverage under a primary form of medical insurance but could also be eligible for coverage under supplemental insurance policies that may be maintained by the same carrier or another carrier. As such, when a particular policy holder encounters an event that may justify filing a claim and receiving benefits under the primary policy, the policy holder may also be entitled to file a claim and receive benefits under a supplemental policy.

For several reasons, insured persons (“insured”) often fail to fully avail themselves of the benefits to which they are entitled after they experience a qualifying event. There are several reasons for this, including technological and practical barriers. To begin with, the insured may be too occupied with the ramifications of the qualifying event to identify all benefits for which they are eligible to receive. Further, policy details may be complicated and difficult for the insured to navigate.

Because of these practical barriers, it is desirable for insurance carriers to provide and utilize systems to facilitate the filing of claims on such benefits. However, technical challenges must be overcome in order to create such solutions. First, policy data for all of the policies of the insured is stored in different databases, in different data schema, and using differing types and formats. Thus heterogeneity of such databases and data make it technically challenging to synthesize the policy data for processing and analysis. Second, identifying all relevant policies for a particular insured is a necessary step but requires creating links between the policies that do not exist because policy information is not designed to be so connected. Third, the information in claim and coverage data may be inaccurate or incomplete and any solution must account for discrepancies or for limited or inaccurate data. Fourth, determining whether a particular event will result in a supplemental claim is difficult to discern. These technical challenges pose significant impediments that must be overcome. Known systems and methods are unable to do so.

As such, systems and methods for predicting that an event is likely to result in a payable supplemental insurance claim, and for automatically processing such claims, are desired.

### BRIEF SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In an aspect, a computing system includes a processor. The computing system also includes a memory having a set of instructions, which when executed by the processor, cause the computing system to identify a plurality of claim records that are associated with first heterogeneous data schemas, and identify a plurality of coverage records that are associated with second heterogeneous data schemas, where the second heterogeneous data schemas are at least partially distinct from the first heterogeneous data schemas, further where at least part of the first heterogeneous data schemas and the second heterogeneous data schemas are associated with a human-readable format. The set of instructions, which when executed by the processor, cause the computing system to transform, with a joint schema, the plurality of claim records from the first heterogeneous data schemas and the plurality of coverage records from the second heterogeneous data schemas to a homogeneous data schema to generate transformed claim records and transformed coverage records, where the homogeneous data schema is associated with a machine-readable format. The set of instructions, which when executed by the processor, cause the computing system to identify a qualifying claim from a first transformed claim record of the transformed claim records, where the first transformed claim record has an incurred date. The set of instructions, which when executed by the processor, cause the computing system to also predict that the qualifying claim results in a supplemental claim by scanning the transformed coverage records and determining that at least one first coverage record of the transformed coverage records specifies that a claimant master record associated with the first transformed claim record is entitled to a supplemental claim at a time of the incurred date. The set of instructions, which when executed by the processor, cause the computing system to integrate the first transformed claim record and the at least one first coverage record to identify supplemental claim attributes. The set of instructions, which when executed by the processor, cause the computing system to also define a supplemental claim record based on the supplemental claim attributes. Other embodiments of this aspect include corresponding computer systems, apparatus, and computer programs recorded on one or more computer storage devices, each configured to perform the actions of the described above.

One general aspect includes at least one computer readable storage medium can include a set of instructions. The set of instructions, which when executed by the computing device, cause the computing device to identify a plurality of claim records that are associated with first heterogeneous data schemas. The set of instructions, which when executed by the computing device, cause the computing device to identify a plurality of coverage records that are associated with second heterogeneous data schemas, where the second heterogeneous data schemas are at least partially distinct from the first heterogeneous data schemas, further where at least part of the first heterogeneous data schemas and the second heterogeneous data schemas are associated with a human-readable format. The set of instructions, which when executed by the computing device, cause the computing device to transform, with a joint schema, the plurality of claim records from the first heterogeneous data schemas and the plurality of coverage records from the second heterogeneous data schemas to a homogeneous data schema to generate transformed claim records and transformed coverage records, where the homogeneous data schema is associated with a machine-readable format. The set of instructions, which when executed by the computing device, cause the computing device to identify a qualifying claim from a first transformed claim record of the transformed claim records, where the first transformed claim record has an incurred date. The set of instructions, which when executed by the computing device, cause the computing device to predict that the qualifying claim results in a supplemental claim by scanning the transformed coverage records and determining that at least one first coverage record of the transformed coverage records specifies that a claimant master record associated with the first transformed claim record is entitled to a supplemental claim at a time of the incurred date. The set of instructions, which when executed by the computing device, cause the computing device to also includes integrate the first transformed claim record and the at least one first coverage record to identify supplemental claim attributes. The set of instructions, which when executed by the computing device, cause the computing device to define a supplemental claim record based on the supplemental claim attributes. Other embodiments of this aspect include corresponding computer systems, apparatus, and computer programs recorded on one or more computer storage devices, each configured to perform the above actions.

One general aspect includes a method executed with a computing system. The method includes identifying a plurality of claim records that are associated with first heterogeneous data schemas. The method also includes identifying a plurality of coverage records that are associated with second heterogeneous data schemas, where the second heterogeneous data schemas are at least partially distinct from the first heterogeneous data schemas, further where at least part of the first heterogeneous data schemas and the second heterogeneous data schemas are associated with a human-readable format. The method also includes transforming, with a joint schema, the plurality of claim records from the first heterogeneous data schemas and the plurality of coverage records from the second heterogeneous data schemas to a homogeneous data schema to generate transformed claim records and transformed coverage records, where the homogeneous data schema is associated with a machine-readable format. The method also includes identifying a qualifying claim from a first transformed claim record of the transformed claim records, where the first transformed claim record has an incurred date. The method also includes predicting that the qualifying claim results in a supplemental claim by scanning the transformed coverage records and determining that at least one first coverage record of the transformed coverage records specifies that a claimant master record associated with the first transformed claim record is entitled to a supplemental claim at a time of the incurred date. The method also includes integrating the first transformed claim record and the at least one first coverage record to identify supplemental claim attributes. The method also includes defining a supplemental claim record based on the supplemental claim attributes. Other embodiments of this aspect include corresponding computer systems, apparatus, and computer programs recorded on one or more computer storage devices, each configured to perform the actions of the methods.

One general aspect includes at least one computer readable storage medium comprising a set of instructions, which when executed by a computing device, cause the computing device to identify a plurality of claim records that are associated with first heterogeneous data schemas, identify a plurality of coverage records that are associated with second heterogeneous data schemas, where the second heterogeneous data schemas are at least partially distinct from the first heterogeneous data schemas, further where at least part of the first heterogeneous data schemas and the second heterogeneous data schemas are associated with a human-readable format. The set of instructions, which when executed by the computing device, cause the computing device to transform, with a joint schema, the plurality of claim records from the first heterogeneous data schemas and the plurality of coverage records from the second heterogeneous data schemas to a homogeneous data schema to generate transformed claim records and transformed coverage records by removing one or more of extraneous characters, unnecessary characters or redundant characters in the plurality of claim records and the plurality of coverage records, and converting the plurality of claim records and the plurality of coverage records, that have the one or more of the extraneous characters, the unnecessary characters or the redundant characters removed, into hash values, wherein the homogeneous data schema is associated with a machine-readable format. The set of instructions, which when executed by the computing device, cause the computing device to identify a qualifying claim from a first transformed claim record of the transformed claim records, wherein the first transformed claim record has an incurred date and predict that the qualifying claim results in a supplemental claim by scanning the transformed coverage records and determining that at least one first coverage record of the transformed coverage records specifies that a claimant master record associated with the first transformed claim record is entitled to a supplemental claim at a time of the incurred date. The set of instructions, which when executed by the computing device, cause the computing device to integrate the first transformed claim record and the at least one first coverage record to identify supplemental claim attributes and define a supplemental claim record based on the supplemental claim attributes. Other embodiments of this aspect include corresponding computer systems, apparatus, and computer programs recorded on one or more computer storage devices, each configured to perform the above actions.

### BRIEF DESCRIPTION OF THE DRAWINGS

The disclosure will be better understood, and features, aspects and advantages other than those set forth above will become apparent when consideration is given to the following detailed description thereof. Such detailed description makes reference to the following drawings, wherein:

FIG. 1 is a functional block diagram of an example insurance claim processing system including primary insurance policy systems and supplemental insurance policy systems.

FIG. 2 is a functional block diagram of an example computing device that may be used in the predictive supplemental claim system described.

FIG. 3 is a functional block diagram of a predictive supplemental claim system that may be deployed within the system of FIG. 1 using the computing devices shown in FIG. 2.

FIG. 4 is a flow diagram representing the supplemental claim prediction and processing method from the perspective of the predictive supplemental claim server shown in FIG. 3.

FIG. 5 is a diagram of elements of one or more example computing devices that may be used in the system shown in FIGS. 1 and 3.

In the drawings, reference numbers may be reused to identify similar and/or identical elements.

### DETAILED DESCRIPTION

Unless defined otherwise, all technical and scientific terms used herein have the same meaning as commonly understood by one of ordinary skill in the art to which the disclosure belongs. Although any methods and materials similar to or equivalent to those described herein can be used in the practice or testing of the present disclosure, the preferred methods and materials are described below.

As used herein, the term “string metric”, “string similarity metric”, “string difference”, or “string distance” refer to measurements of differences (or relative similarities) between input strings of characters. Thus, a string metric provides a number indicating an algorithm-specific indication of distance. One example of a string metric is a Levenshtein distance (or edit distance) which operates between two input strings, returning a number equivalent to the number of substitutions and deletions needed in order to transform one input string into another. Other examples of string metrics may include a Damerau-Levenshtein distance, a Sorensen-Dice coefficient, a block distance (or L1 distance or city block distance), a Hamming distance, a Jaro-Winkler distance, a simple matching coefficient (SMC), a Jaccard similarity or Jaccard coefficient (or Tanimoto coefficient), a Tversky index, an overlap coefficient, a variational distance, a Hellinger distance, a Bhattacharyya distance, an information radius (or Jensen-Shannon divergence), a skew divergence, a confusion probability, a Tau metric (i.e., an approximation of the Kullback-Leibler divergence), a Fellegi and Sunters metric (SFS), maximal matches, grammar-based distance, or a TFIDF distance metric. As used herein, algorithms for “string metrics”, “string similarity metrics”, “string differences”, or “string distances” are used to provide fuzzy matching between attributes of insurance information including, for example, fuzzy matching between data elements used to identify insurance claim claimants (“claimants”) and insurance policy holders (“insured” or “covered”). One example of a string metric used in the systems and methods described herein is the Levenshtein distance (or edit distance) which defines the distance between two strings a,b (of length and |a| and |b| respectively) is given by leva,b(|a|,|b|) where

$${lev}_{a , b} ( i , j ) = \{ \begin{matrix}max ( i , j ) & if min ( i , j ) = 0 , \\ min \{ \begin{matrix}{lev}_{a , b} ( i - 1 , j ) + 1 \\ {lev}_{a , b} ( i , j - 1 ) + 1 \\ {lev}_{a , b} ( i - 1 , j - 1 ) + {1}_{( {a}_{i} \neq {b}_{j} )}\end{matrix} \} & otherwise .\end{matrix} \}$$

In other examples, other string metrics, including those described and referenced above, may be used with the systems and methods described herein.

As used herein, the term “extract, transform, load” or “ETL” refers to an approach of extracting data from one or more data sources, transforming the data to a new context than that of the source, and loading the data into a new data target. Data extraction involves extracting data from homogeneous or heterogeneous sources. Data transformation processes data by data cleansing and transforming the cleansed data into a proper, homogenous storage format and structure for the purposes of querying and analysis. Data loading describes the insertion of data into the final target database such as an operational data store, a data mart, a data lake or a data warehouse. As used herein, ETL is used to facilitate extracting claim records and coverage records from the database systems described, transforming the claim records and the coverage records to use a common data schema, and loading the transformed claim and coverage records for analytic purposes.

As used herein, the term “data schema” (or “database schema”) is the structure of a particular database described in a formal language supported by a database management system (“DBMS”) used to implement the particular database. The term “schema” refers to the organization of data as a blueprint of how the database is constructed (divided into database tables in the case of relational databases). All constraints are expressible in the same formal language. A database can be considered a structure in realization of the database language.

Traditional insurance coverage includes primary insurance policies and supplemental insurance policies. In the example of health insurance, a primary insurance policy is an insurance policy that typically provides coverage to reimburse policy holders (also referred to as “insured”) for a wide range of medical services, prescriptions, and related costs that may be incurred in association with a particular event (e.g., a medical issue such as an infection, an accident, or a heart attack) or to compensate for costs associated with other kinds of care (e.g., wellness visits or preventative care). By contrast, supplemental insurance policies (or additional insurance policies or riders) are agreements between the insured and an insurer (that may or may not be the primary insurer) to provide supplemental coverage (or additional coverage) that is typically not available through the primary policies. The supplemental insurance policies typically provide benefits when certain events occur. Some categories of supplemental insurance policies include: (1) life insurance, (2) accidental death and dismemberment insurance (or “AD&D insurance”), (3) disability insurance, (4) hospital indemnity insurance (or “hospital confinement insurance”), (5) critical illness insurance, and (6) supplemental service insurance to cover procedures not covered by a primary insurance policy such as dental care or vision care. The foregoing list is provided by way of example, but not limiting. Thus, supplemental insurance policies exist that cover costs additional resulting from a triggering event that are covered in addition to a primary plan. Such supplemental insurance policies may be obtained (or secured) by employees, employers, beneficiaries, or combinations thereof.

Insured parties (also referred to as insured, covered, or covered parties) often fail to obtain benefits available under their supplemental insurance policies for a variety of reasons ranging from difficulties in processing, to confusion about the availability of benefits, to a belief that benefits have already been filed for or received. Accordingly, systems and methods are desired by the insured to address such problems by facilitating automated processing of supplemental claims. To accommodate such a need, insurance carriers may wish to provide such automated processing of supplemental claims. However, there are technological barriers that prevent existing claims processing systems from accurately predicting that a triggering event is likely to result in a supplemental insurance claim, and to automatically process such supplemental claims. First, policy data for the various policies (e.g., primary policies vs. supplemental policies) of any given insured is stored in different databases, using different data contexts or schema. Thus, as a starting point, all relevant claim and coverage information is not available for analysis by a single processing system, and the data is stored in different contexts rendering processing impossible. Second, creating links between the claim data and coverage data for the primary and supplemental policies is ordinarily necessary, but technically challenging. To begin with, the practical reality of insurance policies means that claimants may not always be a policy holder. Instead, the claimants may be beneficiaries or other parties related to a claimant. Third, the data received in claims and coverage may be inaccurate due to errors in the submission or processing of data. As such, it may be impossible to process or link such data because claimants or insured parties cannot be identified accurately. Fourth, existing insurance claim processing systems lack any method or system for accurately identifying when a supplemental claim is likely to accrue. As such, there are technical obstacles that make it challenging to predict that a triggering event is likely to result in a supplemental insurance claim. Known systems and methods are unable to address such obstacles.

To overcome these known technological problems in predicting that a triggering event is likely to result in a supplemental insurance claim, a predictive supplemental claim system is provided. The predictive supplemental claim system resolves these technological problems with technological solutions that have not been previously applied to solve such problems. Such solutions are neither routine, conventional, nor well-known nor previously used in these contexts. Further, these steps result in practical applications to the problems identified above.

To address the first problem of claim and coverage data being located in different databases and using different schema, a method of integrating such data with a common data schema is proposed and described below. To address the second problem of creating links between the claim data and coverage data and the third problem of inaccurate or erroneous identifiers, a method of calculating a string difference between the claimant identifier and each of the coverage identifiers is proposed is proposed and described below. To address the fourth problem of failure to accurately identify and generate potential supplemental insurance claim filings, a method of predicting that the qualifying claim results in a supplemental insurance claim is proposed and described below. Variations on these technological solutions, rooted in computing technology, are described in detail below. These methods and systems represent some technological benefits and solutions provided by the disclosure. Further, the systems and methods described herein include additional technological solutions described below. Additionally, one result of the systems and methods described is that the predictive supplemental claim system provides error detection, predictive claim determination, and data processing otherwise unavailable through conventional claim processing systems, thereby reducing the rates of error in claim processing and increasing the throughput of such processing.

In an example embodiment, a predictive supplemental claim system is provided for predicting that a claim event results in a supplemental insurance claim. The system includes a first database system having a first database processor and a first database memory. In an example embodiment, the first database system also includes underlying claim databases each containing corresponding claim records. In an example embodiment, the claim records of the first database system are associated with primary claims to primary insurance policies. In this embodiment, each corresponding claim database stores claim records in a distinct claim category using a distinct data schema. The claim categories may distinguish claim information for primary insurance claims based on, for example, insurer (i.e., the identity of the insuring company), insurance policy type (e.g., a high deductible health plan (“HDHP”), a preferred provider organization (“PPO”), or a health maintenance organization (“HMO”), geographical region of coverage (i.e., the geographic region to which the claims of the claim category correspond), claim status (e.g., pending claims or processed claims). The claim databases each have a corresponding data schema that defined based on the associated claim category and associated database software. As described herein, the associated database software (or database management system or “DBMS”) may include, for example, Oracle™, IBM DB/2™, MySQL™, Microsoft SQL Server™, NoSQL, or any other suitable database software. By design, each database software is associated with specific data types, data storage models, and data object definitions. As such, the database software impacts the data schema. As described, implementations of a database for a particular claim category impact the data schema.

As described herein, the claim records of the first database system may include any suitable information associated with processing a primary claim. Generally, claim records include the information within the following categories: (a) definition data; (b) provider data; (c) facility data; (d) insurer data; (e) claim processing data; (f) claim facts data; (g) claimant data; (h) date data; and (i) claim resolution data.

Definition data includes information to define crucial aspects of a particular claim record including, for example, a unique claim identifier, a claim status code, a provider identifier, an insurance identifier, a claimant identifier, a creation date, an update date, a financial amount claimed, and a financial amount approved.

Provider data includes information to identify a particular provider(s) (e.g., provider name(s), identifiers), provider qualifications, provider rate information, and other suitable details.

Facility data includes information to identify the facility in which services are provided (or were provided) including, for example, facility identifier, facility name, facility details, and facility location information.

Insurer data includes information to identify the insurer including, for example, the identifier of the insurance company, the name of the insurance company, and the name of the insurance sub-group, program, or offering associated with the claim.

Claim processing data includes information relevant to the processing of the claim including, for example, the unique claim identifier, a date for the claim (“incurred date”), and a claim processing status.

Claim facts data includes any suitable data related to the details of the claim including, for example, unique claim identifier, fact data related to the financial claims, fact data related to the services rendered, and fact data related to the patient condition or patient illness that necessitated treatment.

Claimant data includes information related to the claimant master record (e.g., a master record containing data related to a particular claimant) including, for example, the full name of the claimant, the address of the claimant, the date of birth of the claimant, unique identifiers for the claimant, the sex and/or gender of the claimant, other claimant details. In some cases, the claimant is not a named policy holder of the primary insurance and is, instead, a beneficiary of a covered policy holder. In such cases, the claimant data may also specify the full name of the policy holder, the address of the policy holder, the date of birth of the policy holder, unique identifiers for the policy holder, the sex and/or gender of the policy holder, the relationship between the policy holder and the claimant, and other policy holder details. However, in many cases such information regarding the claimant or the policy holder is incomplete or inaccurate.

Date data includes time and date records associated with the claim identifying, for example, the date of the incident leading to the claim, the date of the treatment, the date of the filing of the claim, the date of each adjudication (if any), the date of the resolution of the claim (if any), and the date of the payment of the claim (if any).

Claim resolution data includes any information bearing on how the claim has been processed or is being processed including, for example, any adjudications regarding the claim, any dispute, any denial, any elements of the claim that have been withdrawn or terminated, any elements of the claim that have been processed, and any elements of the claim that have been paid.

The predictive supplemental claim system also includes a second database system with a second database processor and a second database memory. The second database system also includes coverage records associated with supplemental insurance policies. In some examples, the second database also includes supplemental claim records associated with the claim records. The coverage records define supplemental coverage policies and include related coverage record data (or “coverage data”) including at least: (a) identifiers for the covered insurance holder, (b) insurer data identifying the insurer, (c) insured and dependent fact data (including, for example, names, addresses, relationships to the insured, and unique identifiers for each), (d) effective date(s) of the insurance, (e) definitions for the supplemental insurance policy including, for example, definitions, coverage limits, coverage terms, coverage deductibles, coverage exclusions, and adjudicatory requirements.

The predictive supplemental claim system also includes a predictive supplemental claim processing server (or “processing server”) that is configured to predict that a claim event results in a supplemental insurance claim. The processing server includes a processor and a memory. The processing server is in communication with the first database system and the second database system. In some embodiments, the processing server may be in communication with one or more database systems containing additional primary claim records, primary coverage records, supplemental coverage records, or supplemental claim records. As such, the processing server may be in communication with additional databases depending on the architecture and design of a given insurance claim processing system.

The processing server receives multiple claim records extracted from claim databases of the first database system. Each claim record is associated with a claim category and has a data schema corresponding to its respective claim database. Each claim record includes corresponding claim data including at least a claimant identifier. The claimant identifier may include one or several data records that can be used to identify the claimant including, for example, a name, a date of birth, a social security number, and an address. The claimant identifier may also be provided along with information related to the insured party associated with the insurance claim. In such examples, the insured party may variously be the claimant, the spouse of the claimant, or a dependent of the claimant. Such insured information may include, for example, the name, date of birth, social security number, or address of the insured along with the relationship between the insured and the claimant. Notably, in many examples, the actual claim records include limited, incorrect, or incomplete claimant data and may include no data regarding the insured whatsoever. The processing server is configured to address the technical problems that arise when such information is unavailable, incorrect, or incomplete, using the techniques described below.

In one example, the processing server receives claim records from at least two claim databases having distinct DBMS (from one another) and distinct data schemas (from one another). In other embodiments, the processor may receive claim records extracted from one claim database, two claim databases, or more claim databases. In such examples, the extracted claim records may be associated with one or more than one DBMS and one or more than one distinct data schema. The data schema may be determined, at least in part, based on the associated DBMS. In other words, the data schema for a claim record varies depending on which database software is used. Thus, in other examples, the processing server receives claim records from m claim databases having m distinct DBMS and m distinct data schemas. In some examples, the processing server receives the multiple claim records extracted from at least two claim databases, wherein each of the claim databases utilizes a distinct database software.

The processing server is also configured to receive coverage records extracted from the second database system. In an example embodiment, the coverage records include at least records for supplemental insurance policies. The records for supplemental insurance policies include at least coverage records for such policies. In some cases, the records also include supplemental claim records (e.g., claim records related to the supplemental policies rather than primary policies). In some embodiments, the coverage records also include records for primary insurance policies. The coverage records each have a corresponding coverage identifier and a corresponding data schema. Like the claim records, the data schema for the coverage records corresponds in part with the DBMS associated with the second database system. The coverage identifier may include one or several data records that can be used to identify the insured including, for example, a name, a date of birth, a social security number, and an address. The coverage identifier may also be provided along with information identifying beneficiaries of the insured including the spouse of the claimant or a dependent of the claimant along with information regarding such beneficiaries. Such beneficiary information may include, for example, the name, date of birth, social security number, or address of the beneficiary along with the relationship between the insured and the beneficiary. The data schema of the coverage records is each determined, at least partially, based on the second database server and the associated DBMS. In other words, the data schema for a coverage record varies depending on which database software is used. In some examples, the second database system may include one or more databases with corresponding DBMS and a corresponding unique data schema. Thus, in other examples, the processing server receives coverage records from n databases containing coverage records (“coverage databases”) having n distinct DBMS and n distinct data schemas. In some examples, the processing server receives the multiple coverage records extracted from at least two coverage databases, wherein each of the coverage databases utilizes a distinct database software.

The claim records and the coverage records described may be extracted using any suitable method including ETL, data migration, data retrieval, data mining, scraping, scheduled or batched extraction, command line extraction, or GUI based extraction. In one example, the records are extracted using an ETL or data migration tool such as Microsoft™ SQL Server Integration Services (“SSIS”). In another example, the records are extracted through a batch process. In a third example, the records are extracted using a recurring loop that queries a set of information stores to identify any new records that have not previously been extracted.

In all embodiments, the processing server is configured to transform the claim records, coverage records, and any other data records from distinct data schema (based on their heterogeneous DBMS and data contexts) to utilize a common data schema. Such transformation allows the processing server to perform database queries and functions across all extracted claim records and coverage records in order to facilitate the functions described. Without such transformation, the processing server would be unable to perform such functions or to provide the benefits described herein. In other words, the processing server transforms the claim records and the coverage records from having m+n distinct data schema to having a single homogenous data schema.

In at least one example, the processing server utilizes a pre-defined joint schema to perform such transformation. The joint schema is designed to allow transformation of all data in the coverage records and claim records and to persist data and metadata to convert from the schema requirements of each DBMS. The processing server applies the joint schema to design transformation queries to process each claim record, coverage record, and other record. Upon such transformation, the claim records are referred to as transformed claim records containing transformed claim data and the coverage records are referred to as transformed coverage records containing transformed coverage data.

The pre-defined joint schema is described below. The pre-defined joint schema can include conversion of the claim records and the coverage records from first and second heterogeneous data schemas, that represent data in a human-readable format, to a homogeneous data schema that represents data in a machine-readable format (e.g., not a human-readable format). Data in the homogeneous data schema can be efficiently processed and analyzed by a computing device but a human being can be unable to fully understand and appreciate the data in the homogeneous format. Thus, the claim records and the coverage records can be transformed to transformed claim records and transformed coverage records.

The pre-defined joint schema can include removing extraneous, unnecessary and/or redundant characters in the claim records and the coverage records. For example, the claim records and the coverage records can include characters which facilitate interpretation by a human being. For example, a social security number and/or phone number, may have a format including numbers and hyphens. Hyphens can aid a user in discerning and remembering the phone number and/or the social security number. Such characters (e.g., characters which do not contribute to a unique identifying number and are inserted to aid a user's understanding and recall of the number) can be removed since a machine does not require such characters for processing, and maintaining the characters consumes power to process and memory to store.

For example, suppose that the claim records and coverage records including a social security number “123-45-6789.” The joint schema can include removal of the hyphens from the social security number to remove the hyphens, resulting in “123456789.” Doing so significantly enhances computer efficiency, reduces processing power, reduces memory footprint and reduces latency. That is, examples may include analyzing the claim records and the coverage records for matches between claimant identifiers of the claim records and coverage identifiers of the coverage records. Removing unnecessary and redundant characters from the claimant identifiers and the coverage identifiers reduces a memory footprint to store the redundant characters. Furthermore, doing so streamlines the analysis to reduce an amount of data that is compared and searched, resulting in an enhanced process that operates with enhanced efficiency. Extraneous, unnecessary and/or redundant characters can include any character that does not distinguish the claimant identifiers and the coverage identifiers (e.g., each entry of a particular field such as social security number includes the same character, where the particular field has numerous entries corresponding to different users), is unnecessary or fails to be a unique identifier. In some examples, the unnecessary and/or redundant characters are any non-alphanumeric character.

Extraneous and/or unnecessary characters can be any character that is not necessary or usable by the field type. For example, a social security number (SSN) should ideally only contain numerical values, and thus some examples automatically remove any non-numeric values including any character found in the alphabet, punctuation, or dashes in the SSN. In other fields (e.g., policy numbers) the alpha-numeric values can serve purpose and are thus retained. A policy number example can be “AI123456789.” The “AI” can represent that the policy type is an “AI” type policy. The additional numerical values can individually identify the policy number. As a result, examples generate field-by-field definitions that are created for each field. However, some characters are always extraneous or unnecessary. For example, spaces are removed. Further, since most data is in a primary language (e.g., English), any characters (e.g., g, HI) that are only utilized in other languages (e.g., Cyrillic alphabet) would be removed. Examples can also remove formatting characters, such as new line feed characters, carriage returns, tabs, or other unusual special characters. These formatting characters do not aid in matching, and can actually hinder matching by causing unneeded comparisons, and so examples remove formatting characters.

As noted above, the pre-defined joint schema can include removal of redundant alphanumeric values. For example, if each respective data entry of a field of the claim records and coverage records includes a same character in a same position of the respective data entry, such a character can be removed and is classified as an unnecessary and/or redundant character. For example, if in a social security field (e.g., a field), each social security number (e.g., a respective data entry) of the claimant identifiers and coverage identifiers includes a value of “1” in a same position (e.g., each social security number has a format “1XX-XXX-XXXX” where X can be any number and vary between different entries), the “1” can be safely removed as the “1” does not serve to distinguish between the social security numbers since all the social security numbers include the number “1” in the same position. Doing so similarly enhances computer efficiency, reduces processing power, reduces memory footprint and reduces latency as noted above.

Redundant characters can occur less frequently than extraneous and/or unnecessary characters. As an example, the value of “Spouse” can be shortened or abbreviated to just “S,” and then the “S” is converted to a first integer coded value (e.g., 2). The same is true of gender where examples can modify Male to “M,” and then assign “M” a second integer value (e.g., 0).

The pre-defined joint schema can include converting the claim records and the coverage records into a condensed, integer format. After the extraneous, unnecessary and/or redundant characters are removed, the resulting claim records and the coverage records (which have the extraneous, unnecessary and/or redundant characters removed) are converted into simplified integer formats. For example, if one record of the resulting claim records and the coverage records is in a float format, such a record would be converted from the float format into an integer format. Furthermore, in some examples, some complex integer values can be converted into a simplified integer format. For example, if a date is presented as 12202001 (representing the date 12/20/2001), such a date can be simplified to 122001 (remove the “20” from the date “2001”) to represent the date in a condensed format while still accurately representing the date. Indeed, modifying the formats (e.g., longer integer format or float format) of the resulting claim records and the coverage record to the condensed integer format results in significant processing power reductions and hardware simplification. That is, floating point operations consume more power and energy, operate on specialized and complicated floating point hardware, and execute longer latency operations relative to integer point operations and hardware. Thus, examples herein process condensed integer numbers.

The pre-defined joint schema can include converting words of the claim records and the coverage records into a condensed format (e.g., abbreviation). In some examples, if entries of the field are in a word format, examples shorten such entries to an abbreviation to achieve significant reduction in memory while reducing processing power and speed. For example, if the field is “gender,” the entries may be abbreviated to “F” (female) or “M” (Male). Another example is the field “marital status,” which can be abbreviated to “M” (married), “S” (single), “W” (widow), etc. In some examples, the word formats (either the full or abbreviated versions) can also be converted into integer values for lower latency and enhanced processing.

For example, a first entry (e.g., M or Male) of a field can be converted to a first integer value (e.g., 0), and a second entry (e.g., F or Female) of the field can be converted to a second integer value (e.g., 1). Doing so can dramatically speed up processing. Examples can convert an entire database of personal identifiable information (PII) information to integer values similar to the above description, and can create a hashed (e.g., coded) value such as indicated below:

TABLE I

| | | | | Relation- | |
|---|---|---|---|---|---|
| | | Date of | | ship | |
| | SSN | birth | Gender | Code | Hash Value |
| First | 123- | Apr. 30, | M | Spouse | 12345678901970043002 |
| User | 456- | 1970 | | | |
| | 7890 | | | | |
| Second | 123- | Sep. 27, | M | Dependent | 12365409812022092703 |
| User | 654- | 2022 | | | |
| | 0981 | | | | |

The hash values are concatenations of the other fields. For example, as noted in Table I, the hash value of the first user is “12345678901970043002.” To do so, the SSN, date-of-birth, gender and relationship code values are concatenated together. Specifically, “1234567890” in the hash value is the SSN, “19700430” in the hash value is the date-of-birth in YYYYMMDD format, “0” is the gender value, and “2” is the value of the relationship code (e.g., spouse). The has value for the second user is similarly constructed.

Of course the hash values do not readily make sense to human beings, but hash values are much faster for a machine to process with built in bits and/or numbers to compare that is a single value instead of all the human readable values. In each exemplary situation discussed above, the spacing will always be the same, so the first 9 digits represents the SSN, the next 8 digits represent the date-of-birth, the next single digit is the gender, and the last digit is the relationship code. Thus, each has value always have the same number of digits with unknown values being a different assigned value. For example, an unknown gender can be a value of “0” or

The pre-defined joint schema can include correcting errors. Some examples can further automatically correct errors in fields to presumed meanings. For example, if the field is gender, and an entry is “mail,” some examples can correct the spelling of “mail” to a presumed spelling “male.” For example, each field can have only one of a few select entries (e.g., gender field has male, female, etc.). Thus, when an ambiguous entry does not correspond to one of the few select entries, examples can identify a string distance (as described above and below) between the ambiguous entry and each of the few select entries, and select one of the entries from the few select entries that has the lowest string distance with the ambiguous entry to replace the ambiguous entry. Thus, each entry can be converted to a standard format.

In some examples, the pre-defined joint schema can include generating a unique hash value for individuals. For example, as noted above with the other aspects of pre-defined joint schema the information of the individual can be standardized into a machine-readable format. To facilitate lower latency searching (e.g., comparisons to identify matching entries), examples further hash the standardized entries. For, example, an individual can have associated integers, such as a date of birth as an integer, and who the user is in an insurance policy, a gender, social security number, etc. All of the different associated integers (and word values) can be hashed to a single value to facilitate searching. That is, instead of executing multiple comparisons to see if each field of a claim record matches each field of a coverage record, examples can execute one comparison between a first hash value (representing each of the fields of the claim record) and a second hash value (e.g., representing each field of the coverage record). The first and second hash values can be encoded values. From a technical perspective, operating with unified hash values that encode all entries of a claim record and/or coverage records results in several benefits, including lower processing power, lower latency, enhanced accuracy, etc.

Indeed, computing systems can operate efficiently and quickly over hash values in a way that human beings could not. For example, it would be counterproductive for a human to convert entries into hash values since doing so would add complexity from a human interpretation perspective, and would actually increase an amount of time a human being would need to process the claim records and the coverage records. In contrast, a computing system significantly benefits from hash values, with lowered latency (e.g., speed is significantly increased for a machine to execute aspects described herein on hash values reducing the time from 8 hours to 1 hour at most) and reduced operational overhead (e.g., less comparisons) as described above, and enhanced accuracy.

In some examples, even if a perfect match is not found between the first hash value (representing each of the fields of the claim record) and the second hash value (e.g., representing each field of the coverage record), an output may nonetheless be provided indicating that a potential match exists between the first hash value and the second hash value if the match is above a threshold. For example, if the first hash value matches the second hash value by 90%, an output can still indicate that the first hash value can potentially match the second hash value, and request human intervention. If a perfect match exists between the first and second hash values, then no human intervention is needed and a claim can be processed based on the perfect match (e.g., a payment of supplemental claims is automatically executed). In such examples, operating on the hash values can drive further automation to execute claims processing (e.g., pay a benefit). Furthermore, some claims processing can require certain data (e.g., address) to be input. Examples herein can retrieve the data from the hash values, and input the data into the claims processing. Thus, having all of the information consolidated in a machine-readable format and in the standard format (e.g., without all extraneous characters) enables examples to provide all of the specific information in an encoded and condensed manner that is highly efficient.

In some examples, the hash values can also be used to execute ad hoc queries and reports. For example, trends can be identified from the ad hoc queries and the reports on the hash values. Various other functions can be executed on the hash values.

As will be discussed below, a final output can be determined (e.g., a supplemental insurance claim record based on the claimant records and the coverage records). As noted above, several modifications can be executed on the claimant records and the coverage records to convert the claimant records and the coverage records into a standard, machine-readable format. Since the claimant records and the coverage records are in the standard machine-readable format, a human being can be unable to determine a meaning of the claimant records and the coverage records (e.g., is unusable by a human being). Thus, the supplemental insurance claim record, the claimant records, and the coverage records are converted from the machine-readable format back into a human-readable format by reversing the above described operations for the pre-defined joint schema.

The processing server is also configured to extract a qualifying claim from the transformed claim records by scanning the corresponding transformed claim data to identify a transformed claim record having an incurred date and obtaining associated claim data including the claimant identifier. In other words, the processing server identifies and obtains a particular qualifying claim from the transformed claim records for analysis. Each claim record (whether primary or supplemental) is associated with an incurred date representing the date on which the claim was made. Association between claim records may be provided through data links, pointers, or other data association. In at least some examples, the server system extracts qualifying claims with incurred dates within a given time period. In some examples, the processing server particularly extracts qualifying claims with incurred dates from the past i days.

The processing server is also configured to predict that the qualifying claim results in a supplemental insurance claim by scanning the transformed coverage data and determining that the transformed coverage data specifies that a claimant identifier is entitled to a supplemental claim at the time of the incurred date. In other words, the processing server scans the qualifying claim to determine whether associated coverage data indicates that the claimant is eligible for a supplemental claim. In some examples, the processing server initially performs transformational data matching (and determines which transformed coverage data corresponds) to the qualifying claim by comparing the claimant identifier (of the qualifying claim) to the coverage identifiers for each of the transformed coverage records (or transformed coverage data). In at least some examples, the claimant identifier and the coverage identifiers are at least one of (a) a name, (b) a social security number, (c) a date of birth, and (d) an address, or any combination thereof. In such examples, the processing server receives the claimant identifier of the qualifying claim and receives the coverage identifiers for each of the transformed coverage data. As described above, in many examples a particular transformed coverage record may contain multiple coverage identifiers (associated with, for example, the insured and each beneficiary). The processing server is configured to calculate a string difference between the claimant identifier and each of the coverage identifiers received. Thus, the processing server attempts to identify possible matches between the claimant identifiers and coverage identifiers. Matches are indicated when the calculated string difference between the claimant identifier of the qualifying claim and a given coverage identifier is zero or falls below a minimum threshold. (In one example, the minimum threshold is predetermined based on an analysis of identifiers, such that the threshold indicates a substantial likelihood of a confirmed match between the claimant identifier and the coverage identifier.) In an example embodiment, the threshold is set to confirm that the match indicates that the claimant identifier and coverage identifier are at least 75% matching. In a second embodiment, the threshold is set to confirm that the match indicates that the claimant identifier and coverage identifier are at least 85% matching. Upon such a match, the processing server is configured to determine that the coverage data specifies that a claimant associated with the claimant identifier is associated with the transformed coverage record associated with the given coverage identifier. The processing server is also configured to scan the transformed coverage data to determine eligibility dates associated with the identified transformed coverage record. Eligibility dates, specified in the transformed coverage data, define the time periods in which an insured may make a claim. The processing server compares the incurred date associated with the qualifying claim to the eligibility dates and determines whether the claimant associated with the claimant identifier is entitled to a supplemental claim at the time of the incurred date. In some examples, the prediction (and any predictive information) is stored in the first database system, the second database system, or a tertiary database system.

In some examples, the matches are performed on multiple claimant identifiers simultaneously. For example, in one example, a match is performed by comparing claimant identifiers and coverage identifiers representing all natural individual identification information including a social security number, a date of birth, and/or a relationship code. In another example, a match is performed by comparing claimant and coverage identifiers including an insurer identification number, a date of birth, and/or a relationship code. In yet another example, family members with natural identification information are compared by comparing claimant and coverage identifiers including a covered subscriber social security number, a date of birth, and a relationship code. In another example, family units with identifying information may be compared by comparing claimant and coverage identifiers including a covered subscriber identifier, date of birth, and relationship code.

As described above, the processing server utilizes various techniques and algorithms to calculate string difference between the claimant identifier and each of the coverage identifiers received. In one example embodiment, the processing server applies the Levenshtein distance algorithm. Accordingly, the processing server is configured to compute a Levenshtein distance specified as leva,b(i,j) between the claimant identifier a, having a length i, and each coverage identifier b, each having a length j, to determine the string difference.

In other words, the processing server determines the Levenshtein distance (or edit distance) between strings for the claimant identifier a, and each coverage identifier, b (of length |a| and βb| respectively). The calculated string difference in this example is given by leva,b(|a|,|b|) where

$${lev}_{a , b} ( i , j ) = \{ \begin{matrix}max ( i , j ) & if min ( i , j ) = 0 , \\ min \{ \begin{matrix}{lev}_{a , b} ( i - 1 , j ) + 1 \\ {lev}_{a , b} ( i , j - 1 ) + 1 \\ {lev}_{a , b} ( i - 1 , j - 1 ) + {1}_{( {a}_{i} \neq {b}_{j} )}\end{matrix} \} & otherwise .\end{matrix} \}$$

In other examples, the processing server may use other algorithmic approaches to calculate a string difference including calculating any of a Damerau-Levenshtein distance, a Sorensen-Dice coefficient, a block distance (or L1 distance or city block distance), a Hamming distance, a Jaro-Winkler distance, a simple matching coefficient (SMC), a Jaccard similarity or Jaccard coefficient (or Tanimoto coefficient), a Tversky index, an overlap coefficient, a variational distance, a Hellinger distance, a Bhattacharyya distance, an information radius (or Jensen-Shannon divergence), a skew divergence, a confusion probability, a Tau metric (i.e., an approximation of the Kullback-Leibler divergence), a Fellegi and Sunters metric (SFS), maximal matches, grammar-based distance, or a TFIDF distance metric.

In some examples, the processing server further determines whether the claimant associated with the qualifying claim has already applied for a supplemental claim. In such examples, the processing server is configured to scan the transformed coverage data for a filed supplemental claim associated with the claimant identifier filed within a predetermined period from the incurred date. Phrased differently, the processing server identifies supplemental claims made by the party associated with the claimant identifier within a period (e.g., within x days) of the incurred date using the identified supplemental policy. Upon determining that no supplemental claim exists, the processing server is configured to predict that the qualifying claim results in a supplemental insurance claim. In some examples, the processing server temporarily (or permanently) stores information extracted from claim and coverage data using, for example, an optional hash or an optional database. The processing server obtains updates to the claim and coverage data to identify, for example, changes to the data including changes to adjudication, processing, or payment statuses. This approach allows the system to more effectively identify changes to claim conditions that may obviate the need for a supplemental claim or revise the terms of a supplemental claim.

In some examples, to determine that the qualifying claim results in a supplemental insurance claim, a historical database can be accessed. For example, a historical database can maintain an association of various qualifying claims and coverage records. That is, the historical database can maintain which qualifying claims resulted in supplemental insurance claims. When a new qualifying claim is identified, the historical database can be scanned to identify whether the new qualifying claim matches any of the existing qualifying claims of the historical database. If a match is detected between the new qualifying claim and a first existing qualifying claim of the existing qualifying claims, examples can then identify if the first existing qualifying claim was associated with a coverage record of the coverage records from the historical database to result in a first supplemental insurance claim(s) of the supplemental insurance claims. If so, examples can determine that the new qualifying claim will also result in the first supplemental insurance claim(s).

Upon making such a prediction, the processing server is configured to prepare and automate the supplemental claim for processing. Specifically, the processing server integrates the transformed claim data and the transformed coverage data to identify supplemental insurance claim attributes necessary to create a supplemental claim. The processing server also defines a supplemental insurance claim record based on the supplemental insurance claim attributes. In at least one example, the processing server defines the supplemental insurance claim record based on a supplemental insurance claim template that defines required data elements for the supplemental insurance claim. The supplemental insurance claim template may be retrieved from the second database system or any other suitable location. In at least one example, the processing server submits the supplemental insurance claim record for processing the supplemental insurance claim.

In some examples, the processing server is also configured to initiate (or trigger) the payment, directly or indirectly, to the insured associated with the supplemental insurance claim record. In such examples, the processing server identifies a payment record included within the transformed coverage data of the coverage identifier associated with the claimant identifier. The payment record includes payment information. The processing server is also configured to instruct a payment system to process the supplemental insurance claim record to transmit payment using the payment record. In at least some examples, the processing server instructs the payment system after first receiving a confirmation that the supplemental insurance claim record was approved. In some such examples, the processing server instructs the payment system to issue payment for an amount corresponding to the approved amount.

In some examples of insurance systems, supplemental benefits are only available after a successful adjudication of the primary associated claim. For example, life insurance and AD&D insurance coverage is typically not available until the underlying primary claim is first adjudicated. The processing server is specifically configured to scan the qualifying claim to determine whether an adjudication has been determined. The processing server is also configured to define the supplemental insurance claim record based on the supplemental insurance claim attributes upon determining that the qualifying claim has been approved in adjudication.

In some examples, the processing server transmits the supplemental insurance claim record to at least one of the claimant and the insured based on correspondence records available in the transformed claim data and the transformed coverage data. In such examples, the processing server provides the claimant or the insured with a reminder to file the claim or a notice that the claim has been filed. In other examples, the processing server transmits the supplemental insurance claim record with a recommendation to file the insurance claim.

In some additional examples, the processing server loads the records and information generated into a database system that may be the first database system, the second database system, or a tertiary database system. Such loading may be performed to provide consistent access to claim and coverage data using a common database schema, and to provide access to the supplemental insurance claim records created by the processing server.

In other examples, the processing server performs repeated checks on the claim records to identify any changes in the status of claims including, for example, changes to adjudication, payment, or processing statuses.

In some examples, the processing server is also configured to utilize a condition coverage database that identifies the conditions that are covered for each insurance policy. As such, during extraction, condition coverage data is extracted and compared to the claim data to determine whether the conditions indicated on the condition coverage data is covered by the supplemental insurance policy. If the condition coverage data indicates that the policy covers the condition specified in the claim data, the processing server may define a supplemental insurance claim record based on the supplemental insurance claim attributes if a supplemental insurance claim is predicted to result from the qualifying claim. If the condition coverage data indicates that the policy does not cover the condition specified in the claim data, the processing server will not define the supplemental insurance claim record. Condition coverage data may specify, for example, which conditions will allow for a supplemental claim to be covered under each of (a) accidental injury policies, (b) critical illness policies, and (c) hospital care policies.

In another example, the processing server is also configured to utilize a consent database that captures and stores the consent of claimants and other covered parties to share information as needed by the systems described. The consent database may be populated based on input directly or indirectly indicating that such consent is provided to allow for any information sharing to perform the functions described herein.

Generally, the systems and methods described herein are configured to perform at least the following steps: receiving multiple claim records extracted from claim databases of the first database system, each claim record associated with a claim category and having a data schema corresponding to its respective claim database, each claim record including corresponding claim data including at least a claimant identifier; receiving multiple coverage records from the second database system, each coverage record having a corresponding coverage identifier, each coverage record having a corresponding data schema; transforming the claim records and the coverage records to use a common data schema; extracting a qualifying claim from the transformed claim records by scanning the corresponding transformed claim data to identify a transformed claim record having an incurred date and obtaining associated claim data including the claimant identifier; predicting that the qualifying claim results in a supplemental insurance claim by scanning the transformed coverage data and determining that the transformed coverage data specifies that a claimant associated with the claimant identifier is entitled to a supplemental claim at the time of the incurred date; integrating the transformed claim data and the transformed coverage data to identify supplemental insurance claim attributes; defining a supplemental insurance claim record based on the supplemental insurance claim attributes; receiving the claimant identifier of the qualifying claim; receiving the coverage identifier for each of the transformed coverage records; calculating a string difference between the claimant identifier and each of the coverage identifiers; upon determining that the calculated difference between the claimant identifier and one of the coverage identifiers is below a minimum threshold, determining that the transformed coverage data specifies that a claimant associated with the claimant identifier is entitled to a supplemental claim at the time of the incurred date; computing a Levenshtein distance specified as leva,b(i,j) between the claimant identifier a, having a length i, and each coverage identifier b, each having a length j, to determine the string difference; scanning the transformed coverage data for a filed supplemental claim associated with the claimant identifier filed within a predetermined period from the incurred date; upon determining that no supplemental claim exists, predicting that the qualifying claim results in a supplemental insurance claim; scanning the qualifying claim to determine whether an adjudication has been determined; upon determining that the qualifying claim has been approved in adjudication, defining the supplemental insurance claim record based on the supplemental insurance claim attributes; identifying a payment record included within the transformed coverage data of the coverage identifier associated with the claimant identifier, the payment record including payment information; instructing a payment system to process the supplemental insurance claim record to transmit payment using the payment record; receiving the claim records extracted from at least two claim databases, each of the claim databases utilizing a database software.

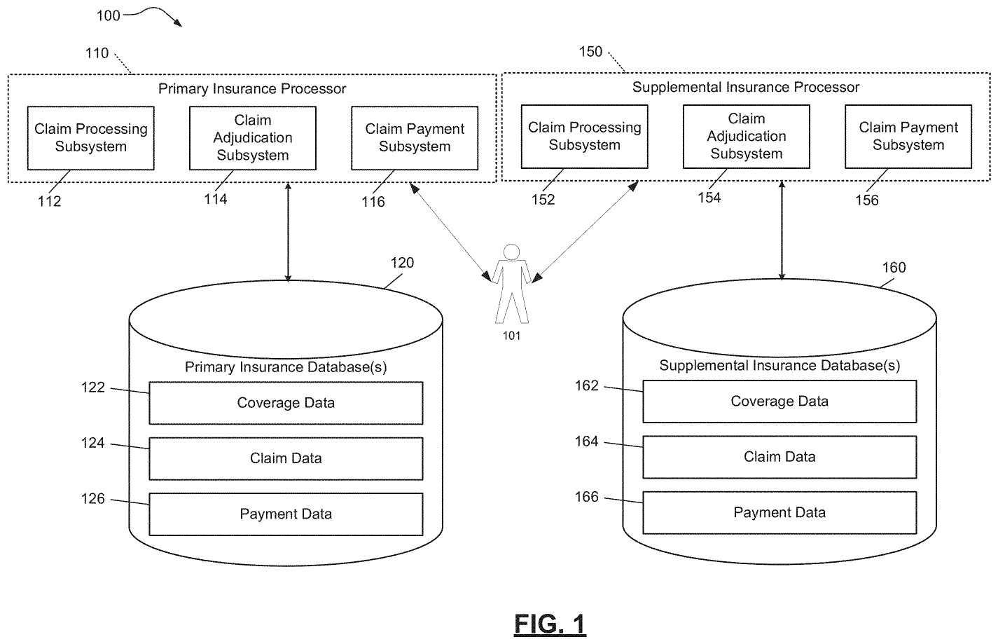

FIG. 1 is a functional block diagram of an example insurance claim processing system 100 including a primary insurance processor system 110 and a supplemental insurance processor system 150. As indicated in the illustration, systems 110 and 150 are entirely distinct with no direct interaction between them. Primary insurance processor system 110 includes subsystems 112, 114, and 116 capable of providing claim processing, claim adjudication, and claim payment respectively. Likewise, supplemental insurance processor system 150 includes subsystems 152, 154, and 156 capable of providing claim processing, claim adjudication, and claim payment respectively. Each system 110 and 150 is associated with a distinct database to support their respective functions. Specifically, primary insurance processor system 110 is associated with a corresponding primary insurance database system 120. As described above and herein, database systems such as database systems 120 and 160 may include one or more than one databases that each are configured to use a DBMS. In some cases the DBMS systems may be distinct from one another. Further, each database is associated with a data schema that may be unique depending on whether the DBMS and clam category are distinct. As such, the databases include data that cannot be processed using common programs. Database systems 120 and 160 include necessary information stored on at least one of their underlying databases. Specifically, primary insurance database system 120 includes coverage data 122, claim data 124, and payment data 126. Likewise supplemental insurance database system 160 includes coverage data 162, claim data 164, and payment data 166.

In operation, users such as user 101 may interact with primary insurance processor system 110 and supplemental insurance processor system 150. However, there is no direct connection between systems 110 and 150. Further, there is no method of analyzing information available from primary claims and predicting that a claim event results in a supplemental insurance claim and automatically processing such supplemental insurance claims. Rather, when an insured party experiences a triggering event, it is necessary for a claimant to file any necessary primary and supplemental claims separately. For clarity, FIG. 1 describes an example insurance claim processing system without the predictive supplemental claim processing server and methods described.

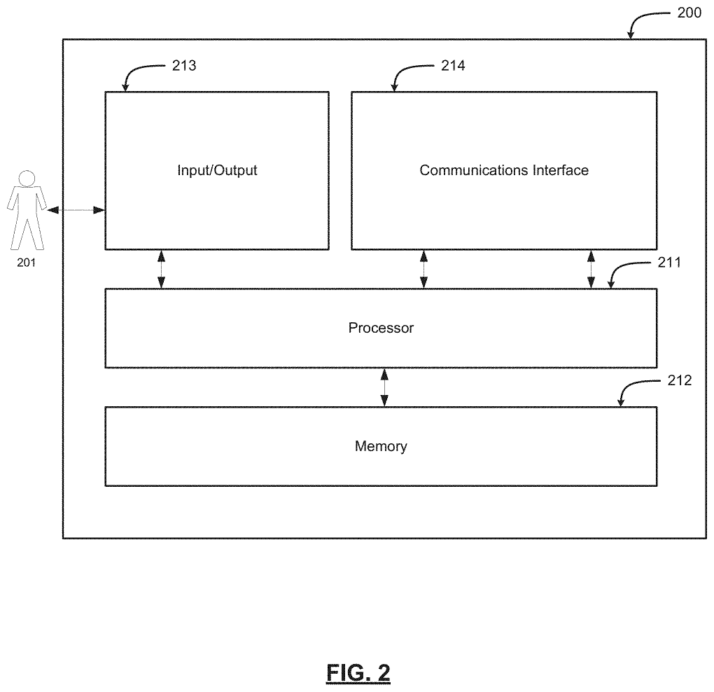

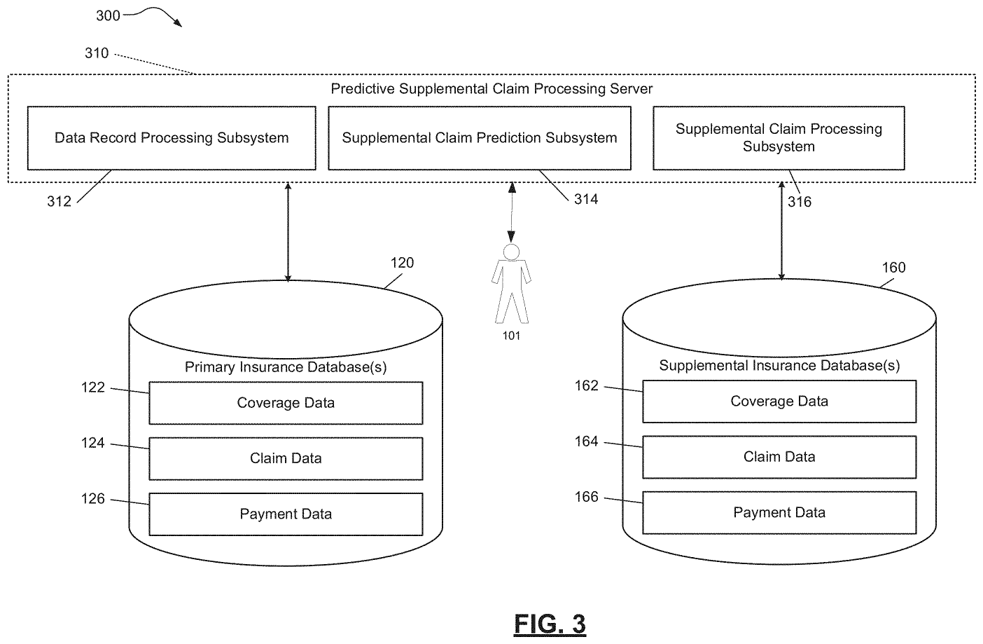

FIG. 2 is a functional block diagram of an example computing device that may be used in the predictive supplemental claim system described, and may represent the predictive supplemental claim processing server, the first database system, and the second database system (all shown in FIG. 3). Specifically, computing device 200 illustrates an example configuration of a computing device for the systems shown herein, and particularly in FIGS. 1 and 3. Computing device 200 illustrates an example configuration of a computing device operated by a user 201 in accordance with one embodiment of the present invention. Computing device 200 may include, but is not limited to, the predictive supplemental claim processing server, the first database system, and the second database system (all shown in FIG. 3), other user systems, and other server systems. Computing device 200 may also include servers, desktops, laptops, mobile computing devices, stationary computing devices, computing peripheral devices, smart phones, wearable computing devices, medical computing devices, and vehicular computing devices. In some variations, computing device 200 may be any computing device capable of the described methods for predicting that a claim event results in a supplemental insurance claim and automatically processing such supplemental insurance claims. In some variations, the characteristics of the described components may be more or less advanced, primitive, or non-functional.

In an example embodiment, computing device 200 includes a processor 211 for executing instructions. In some embodiments, executable instructions are stored in a memory area 212. Processor 211 may include one or more processing units, for example, a multi-core configuration. Memory area 212 is any device allowing information such as executable instructions and/or written works to be stored and retrieved. Memory area 212 may include one or more computer readable media.

Computing device 200 also includes at least one input/output component 213 for receiving information from and providing information to user 201. In some examples, input/output component 213 may be of limited functionality or non-functional as in the case of some wearable computing devices. In other examples, input/output component 213 is any component capable of conveying information to or receiving information from user 201. In some embodiments, input/output component 213 includes an output adapter such as a video adapter and/or an audio adapter. Input/output component 213 may alternatively include an output device such as a display device, a liquid crystal display (LCD), organic light emitting diode (OLED) display, or “electronic ink” display, or an audio output device, a speaker or headphones. Input/output component 213 may also include any devices, modules, or structures for receiving input from user 201. Input/output component 213 may therefore include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output and input device of input/output component 213. Input/output component 213 may further include multiple sub-components for carrying out input and output functions.

Computing device 200 may also include a communications interface 214, which may be communicatively coupleable to a remote device such as a remote computing device, a remote server, or any other suitable system. Communication interface 214 may include, for example, a wired or wireless network adapter or a wireless data transceiver for use with a mobile phone network, Global System for Mobile communications (GSM), 3G, 4G, or other mobile data network or Worldwide Interoperability for Microwave Access (WIMAX). Communications interface 214 is configured to allow computing device 200 to interface with any other computing device or network using an appropriate wireless or wired communications protocol such as, without limitation, BLUETOOTH®, Ethernet, or IEE 802.11. Communications interface 214 allows computing device 200 to communicate with any other computing devices with which it is in communication or connection.

FIG. 3 is a functional block diagram of a predictive supplemental claim system 300 that may be deployed within system 100 (shown in FIG. 1) using the computing device 200 (shown in FIG. 2). Specifically, predictive supplemental claim system 300 includes predictive supplemental claim server 310 which is in communication with at least primary insurance database 120 and supplemental insurance database 160. Predictive supplemental claim server 310 includes subsystems capable of performing the methods described herein including at least a data record processing subsystem 312, a supplemental claim prediction subsystem 314, and a supplemental claim processing subsystem 316. Predictive supplemental claim server 310 is in communication with database systems 120 and 160 and thereby has access to coverage data 122 and 162, claim data 124 and 164, and payment data 126 and 166 for each system. Predictive supplemental claim server 310 is capable of using such data to perform the methods described herein by using subsystems 312, 314, and 316.

In operation, predictive supplemental claim server 310 has access to claim records included in claim data 124 from primary insurance database 120 along with all data stored in the databases therein. Claim data 124 may be represented in multiple distinct data schema as described herein. Claim data 124 is organized into claim records for the primary insurance. Predictive supplemental claim server 310 is configured to extract such claim data 124 as a claim records including associated claim data including at least one claimant identifier. In order to determine how to extract and utilize claim data 124, predictive supplemental claim server utilizes data mapping algorithms to identify the locations of claim data 124 within each database 120. In some examples, data mapping requires a pre-existing template, and in other examples data mapping may be performed automatically by scanning database 120 to identify each claim data 124. Predictive supplemental claim server 310 also has access to coverage records included in coverage data 162 from supplemental insurance database 160 along with all data stored in the databases therein. Coverage data 162 may be represented in multiple distinct data schema as described herein. Predictive supplemental claim server 310 is configured to extract coverage records reflected in coverage data 162 from supplemental insurance database 160, where each coverage record has an associated coverage identifier. The coverage records and the claim data each have an associated data schema associated, at least in part, with the corresponding DBMS. Predictive supplemental claim server 310 is configured to transform the claim records and the coverage records to use a common data schema and to make the associated data schema homogenous. In one example, predictive supplemental claim server 310 applies data record processing subsystem 312 to accomplish these steps.

Predictive supplemental claim server 310 is also configured to extract a qualifying claim from the transformed claim records created from claim data 124 by scanning the corresponding transformed claim data from claim data 124 to identify a transformed claim record having an incurred date and obtaining associated claim data 124 including the claimant identifier. Predictive supplemental claim server 310 is further configured to predict that the qualifying claim results in a supplemental insurance claim by scanning the transformed coverage data 162 and determining that the transformed coverage data 162 specifies that a claimant associated with the claimant identifier is entitled to a supplemental claim at the time of the incurred date. In one example, predictive supplemental claim server 310 applies supplemental claim prediction subsystem 314 to accomplish this step.

Predictive supplemental claim server 310 is also configured to integrate the transformed claim data 124 and the transformed coverage data 162 to identify supplemental insurance claim attributes. Predictive supplemental claim server 310 is also configured to define a supplemental insurance claim record based on the supplemental insurance claim attributes. In one example, predictive supplemental claim server 310 applies supplemental claim processing subsystem 316 to accomplish these steps.

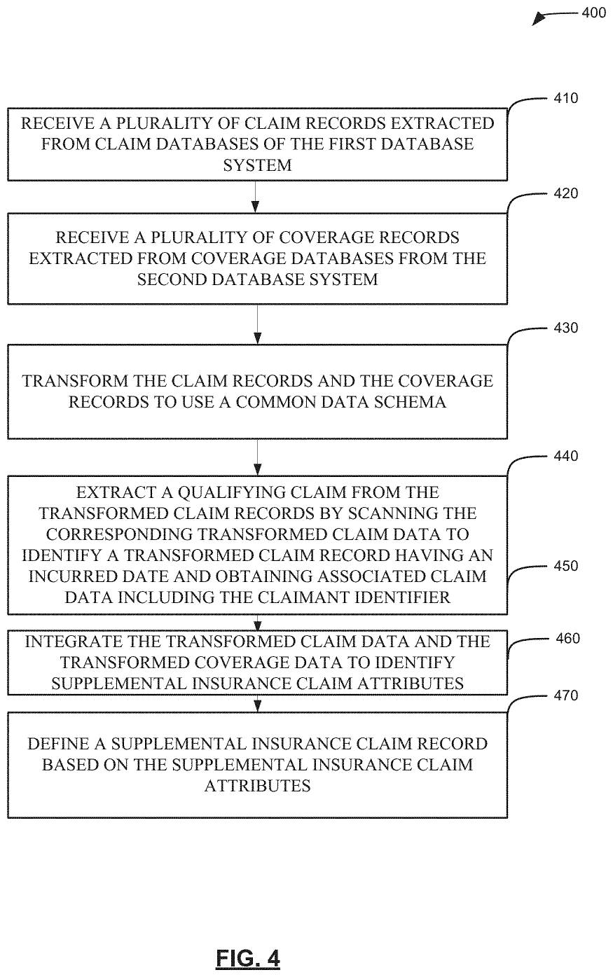

FIG. 4 is a flow diagram 400 representing the supplemental claim prediction process from the perspective of the predictive supplemental claim server 310 (shown in FIG. 3). Specifically, predictive supplemental claim server 310 is configured to receive 410 a claim records extracted from claim databases of the first database system. Each claim record is associated with a claim category and having a data schema corresponding to its respective claim database. Each claim record includes corresponding claim data including at least a claimant identifier. Predictive supplemental claim server 310 is also configured to receive 420 coverage records extracted from coverage databases from the second database system. Each coverage record has a corresponding coverage identifier, and each coverage record has a corresponding data schema. Predictive supplemental claim server 310 is further configured to transform 430 the claim records and the coverage records to use a common data schema. Predictive supplemental claim server 310 is also configured to extract 440 a qualifying claim from the transformed claim records by scanning the corresponding transformed claim data to identify a transformed claim record having an incurred date and obtaining associated claim data including the claimant identifier. Predictive supplemental claim server 310 is additionally configured to predict 450 that the qualifying claim results in a supplemental insurance claim by scanning the transformed coverage data and determining that the transformed coverage data specifies that a claimant associated with the claimant identifier is entitled to a supplemental claim at the time of the incurred date. Predictive supplemental claim server 310 is also configured to integrate 460 the transformed claim data and the transformed coverage data to identify supplemental insurance claim attributes. Predictive supplemental claim server 310 is also configured to define 470 a supplemental insurance claim record based on the supplemental insurance claim attributes.

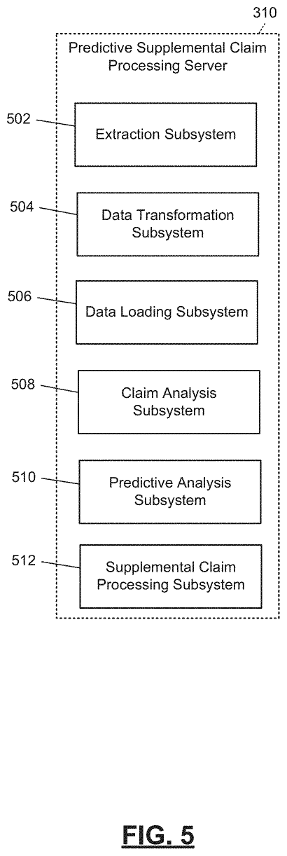

FIG. 5 is a diagram 500 of elements of one or more example computing devices that may be used in the system shown in FIGS. 1 and 3. Specifically, FIG. 5 describes subsystems available to predictive supplemental claim server 310 and capable of providing the functionality described herein. Predictive supplemental claim server 310 includes an extraction subsystem 502 that facilitates the data extraction steps described herein. Subsystem 502 may be represented as a component of data record processing subsystem 312 (shown in FIG. 3). Predictive supplemental claim server 310 also includes a data transformation subsystem 504 that facilitates the transformation of data (including coverage data and claim data) to a homogenous data schema, as described herein. Subsystem 504 may be represented as a component of data record processing subsystem 312 (shown in FIG. 3). Predictive supplemental claim server 310 also includes a data loading subsystem 506 that facilitates the data loading processes described herein that allow the predictive supplemental claim server 310 to receive and process the claim records and coverage records in a homogenous data schema. Subsystem 506 may be represented as a component of data record processing subsystem 312 (shown in FIG. 3). Predictive supplemental claim server 310 also includes a claim analysis subsystem 508 that facilitates extracting a qualifying claim from the transformed claim records and related steps. Predictive supplemental claim server 310 also includes a predictive analysis subsystem 510 that facilitates predicting that the qualifying claim results in a supplemental insurance claim by scanning the transformed coverage data and determining that the transformed coverage data specifies that a claimant associated with the claimant identifier is entitled to a supplemental claim at the time of the incurred date. Subsystem 510 further facilitates steps involving calculation of string differences described herein and verification that no prior supplemental claim has been filed. Subsystem 510 also facilitates steps involving determining that a qualifying claim has been approved in adjudication. Predictive supplemental claim server 310 also includes a supplemental claim processing subsystem 512 configured to handle steps involving processing the supplemental claim including integrating the transformed claim data and the transformed coverage data to identify supplemental insurance claim attributes and defining a supplemental insurance claim record based on the supplemental insurance claim attributes. Subsystem 512 also facilitates processing payment for the supplemental insurance claim by instructing a payment system to process the supplemental insurance claim record to transmit payment using the payment record.

### EXAMPLES

Example 1. A computing system comprising:

a processor; and

a memory having a set of instructions, which when executed by the processor, cause the computing system to:

identify a plurality of claim records that are associated with first heterogeneous data schemas;

identify a plurality of coverage records that are associated with second heterogeneous data schemas, wherein the second heterogeneous data schemas are at least partially distinct from the first heterogeneous data schemas, further wherein at least part of the first heterogeneous data schemas and the second heterogeneous data schemas are associated with a human-readable format;

transform, with a joint schema, the plurality of claim records from the first heterogeneous data schemas and the plurality of coverage records from the second heterogeneous data schemas to a homogeneous data schema to generate transformed claim records and transformed coverage records, wherein the homogeneous data schema is associated with a machine-readable format;

identify a qualifying claim from a first transformed claim record of the transformed claim records, wherein the first transformed claim record has an incurred date;

predict that the qualifying claim results in a supplemental claim by scanning the transformed coverage records and determining that at least one first coverage record of the transformed coverage records specifies that a claimant master record associated with the first transformed claim record is entitled to a supplemental claim at a time of the incurred date;

integrate the first transformed claim record and the at least one first coverage record to identify supplemental claim attributes; and

define a supplemental claim record based on the supplemental claim attributes.
Example 2. The computing system of Example 1, wherein the instructions of the memory, when executed, cause the computing system to:

receive a first coverage identifier of the at least one first coverage record;

calculate a string difference between a first claimant identifier of the qualifying claim and the first coverage identifier based on a number of substitutions and deletions that are needed to transform one of the first claimant identifier and the first coverage identifier into the other of the first claimant identifier and the first coverage identifier, wherein the string difference provides a number indicating a distance between the first coverage identifier and the first claimant identifier, wherein the first claimant identifier is associated with the claimant master record; and

upon determining that the calculated string difference between the first claimant identifier and the first coverage identifier is below a minimum threshold, determine that the at least one first coverage record specifies that the claimant master record associated with the first claimant identifier is entitled to the supplemental claim at the time of the incurred date.
Example 3. The computing system of Example 1, wherein the joint schema includes removal of one or more of extraneous characters, unnecessary characters or redundant characters in the plurality of claim records and the plurality of coverage records.
Example 4. The computing system of Example 1, wherein the joint schema includes removal of characters in the plurality of claim records and the plurality of coverage records that are unnecessary for the computing system to interpret the plurality of claim records and the plurality of coverage records.
Example 5. The computing system of Example 1, wherein the joint schema includes removal of redundant alphanumeric values from the plurality of claim records and the plurality of coverage records.
Example 6. The computing system of Example 1, wherein the joint schema includes conversion of the plurality of claim records and the plurality of coverage records into an integer format.
Example 7. The computing system of Example 1, wherein the joint schema includes conversion of the plurality of claim records and the plurality of coverage records into hash values.
Example 8. At least one computer readable storage medium comprising a set of instructions, which when executed by a computing device, cause the computing device to:

identify a plurality of claim records that are associated with first heterogeneous data schemas;

identify a plurality of coverage records that are associated with second heterogeneous data schemas, wherein the second heterogeneous data schemas are at least partially distinct from the first heterogeneous data schemas, further wherein at least part of the first heterogeneous data schemas and the second heterogeneous data schemas are associated with a human-readable format;

transform, with a joint schema, the plurality of claim records from the first heterogeneous data schemas and the plurality of coverage records from the second heterogeneous data schemas to a homogeneous data schema to generate transformed claim records and transformed coverage records, wherein the homogeneous data schema is associated with a machine-readable format;

identify a qualifying claim from a first transformed claim record of the transformed claim records, wherein the first transformed claim record has an incurred date;

predict that the qualifying claim results in a supplemental claim by scanning the transformed coverage records and determining that at least one first coverage record of the transformed coverage records specifies that a claimant master record associated with the first transformed claim record is entitled to a supplemental claim at a time of the incurred date;

integrate the first transformed claim record and the at least one first coverage record to identify supplemental claim attributes; and

define a supplemental claim record based on the supplemental claim attributes.
Example 9. The at least one computer readable storage medium of Example 8, wherein the instructions, when executed, cause the computing device to:
receive a first coverage identifier of the at least one first coverage record;
calculate a string difference between a first claimant identifier of the qualifying claim and the first coverage identifier based on a number of substitutions and deletions that are needed to transform one of the first claimant identifier and the first coverage identifier into the other of the first claimant identifier and the first coverage identifier, wherein the string difference provides a number indicating a distance between the first coverage identifier and the first claimant identifier, wherein the first claimant identifier is associated with the claimant master record; and

upon determining that the calculated string difference between the first claimant identifier and the first coverage identifier is below a minimum threshold, determine that the at least one first coverage record specifies that the claimant master record associated with the first claimant identifier is entitled to the supplemental claim at the time of the incurred date.
Example 10. The at least one computer readable storage medium of Example 8, wherein the joint schema includes removal of one or more of extraneous characters, unnecessary characters or redundant characters in the plurality of claim records and the plurality of coverage records.
Example 11. The at least one computer readable storage medium of Example 8, wherein the joint schema includes removal of characters in the plurality of claim records and the plurality of coverage records that are unnecessary for the computing device to interpret the plurality of claim records and the plurality of coverage records.
Example 12. The at least one computer readable storage medium of Example 8, wherein the joint schema includes removal of redundant alphanumeric values from the plurality of claim records and the plurality of coverage records.
Example 13. The at least one computer readable storage medium of Example 8, wherein the joint schema includes conversion of the plurality of claim records and the plurality of coverage records into an integer format.
Example 14. The at least one computer readable storage medium of Example 8, wherein the joint schema includes conversion of the plurality of claim records and the plurality of coverage records into hash values.
Example 15. A method executed with a computing system, the method comprising:

identifying a plurality of claim records that are associated with first heterogeneous data schemas;

identifying a plurality of coverage records that are associated with second heterogeneous data schemas, wherein the second heterogeneous data schemas are at least partially distinct from the first heterogeneous data schemas, further wherein at least part of the first heterogeneous data schemas and the second heterogeneous data schemas are associated with a human-readable format;

transforming, with a joint schema, the plurality of claim records from the first heterogeneous data schemas and the plurality of coverage records from the second heterogeneous data schemas to a homogeneous data schema to generate transformed claim records and transformed coverage records, wherein the homogeneous data schema is associated with a machine-readable format;

identifying a qualifying claim from a first transformed claim record of the transformed claim records, wherein the first transformed claim record has an incurred date;

predicting that the qualifying claim results in a supplemental claim by scanning the transformed coverage records and determining that at least one first coverage record of the transformed coverage records specifies that a claimant master record associated with the first transformed claim record is entitled to a supplemental claim at a time of the incurred date;

integrating the first transformed claim record and the at least one first coverage record to identify supplemental claim attributes; and

defining a supplemental claim record based on the supplemental claim attributes.
Example 16. The method of Example 15, further comprising:

receiving a first coverage identifier of the at least one first coverage record;

calculating a string difference between a first claimant identifier of the qualifying claim and the first coverage identifier based on a number of substitutions and deletions that are needed to transform one of the first claimant identifier and the first coverage identifier into the other of the first claimant identifier and the first coverage identifier, wherein the string difference provides a number indicating a distance between the first coverage identifier and the first claimant identifier, wherein the first claimant identifier is associated with the claimant master record; and

upon determining that the calculated string difference between the first claimant identifier and the first coverage identifier is below a minimum threshold, determining that the at least one first coverage record specifies that the claimant master record associated with the first claimant identifier is entitled to the supplemental claim at the time of the incurred date.
Example 17. The method of Example 15, wherein the joint schema includes removing one or more of extraneous characters, unnecessary characters or redundant characters in the plurality of claim records and the plurality of coverage records.
Example 18. The method of Example 15, wherein the joint schema includes removing characters in the plurality of claim records and the plurality of coverage records that are unnecessary for the computing system to interpret the plurality of claim records and the plurality of coverage records.
Example 19. The method of Example 15, wherein the joint schema includes removing redundant alphanumeric values from the plurality of claim records and the plurality of coverage records.
Example 20. The method Example claim 15, wherein the joint schema includes:

converting of the plurality of claim records and the plurality of coverage records into an integer format; and

converting of the plurality of claim records and the plurality of coverage records into hash values.
Example 21. At least one computer readable storage medium comprising a set of instructions, which when executed by a computing device, cause the computing device to:

identify a plurality of claim records that are associated with first heterogeneous data schemas;

identify a plurality of coverage records that are associated with second heterogeneous data schemas, wherein the second heterogeneous data schemas are at least partially distinct from the first heterogeneous data schemas, further wherein at least part of the first heterogeneous data schemas and the second heterogeneous data schemas are associated with a human-readable format;

transform, with a joint schema, the plurality of claim records from the first heterogeneous data schemas and the plurality of coverage records from the second heterogeneous data schemas to a homogeneous data schema to generate transformed claim records and transformed coverage records by:
removing one or more of extraneous characters, unnecessary characters or redundant characters in the plurality of claim records and the plurality of coverage records, and
converting the plurality of claim records and the plurality of coverage records, that have the one or more of the extraneous characters, the unnecessary characters or the redundant characters removed, into hash values, wherein the homogeneous data schema is associated with a machine-readable format;
identify a qualifying claim from a first transformed claim record of the transformed claim records, wherein the first transformed claim record has an incurred date;

predict that the qualifying claim results in a supplemental claim by scanning the transformed coverage records and determining that at least one first coverage record of the transformed coverage records specifies that a claimant master record associated with the first transformed claim record is entitled to a supplemental claim at a time of the incurred date;

integrate the first transformed claim record and the at least one first coverage record to identify supplemental claim attributes; and

define a supplemental claim record based on the supplemental claim attributes.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A. The term subset does not necessarily require a proper subset. In other words, a first subset of a first set may be coextensive with (equal to) the first set.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are the BLUETOOTH wireless networking standard from the Bluetooth Special Interest Group and IEEE Standard 802.15.4.

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave). The term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A computing system comprising:
a processor; and
a memory having a set of instructions, which when executed by the processor, cause the computing system to:
identify a plurality of claim records that are associated with first heterogeneous data schemas;
identify a plurality of coverage records that are associated with second heterogeneous data schemas, wherein the second heterogeneous data schemas are at least partially distinct from the first heterogeneous data schemas, further wherein at least part of the first heterogeneous data schemas and the second heterogeneous data schemas are associated with a human-readable format;
transform, with a joint schema, the plurality of claim records from the first heterogeneous data schemas and the plurality of coverage records from the second heterogeneous data schemas to a homogeneous data schema to generate transformed claim records and transformed coverage records, wherein the homogeneous data schema is associated with a machine-readable format;
identify a qualifying claim from a first transformed claim record of the transformed claim records, wherein the first transformed claim record has an incurred date;
predict that the qualifying claim results in a supplemental claim by scanning the transformed coverage records and determining that at least one first coverage record of the transformed coverage records specifies that a claimant master record associated with the first transformed claim record is entitled to a supplemental claim at a time of the incurred date;
integrate the first transformed claim record and the at least one first coverage record to identify supplemental claim attributes; and
define a supplemental claim record based on the supplemental claim attributes.

2. The computing system of claim 1, wherein the instructions of the memory, when executed, cause the computing system to:
receive a first coverage identifier of the at least one first coverage record;
calculate a string difference between a first claimant identifier of the qualifying claim and the first coverage identifier based on a number of substitutions and deletions that are needed to transform one of the first claimant identifier and the first coverage identifier into the other of the first claimant identifier and the first coverage identifier, wherein the string difference provides a number indicating a distance between the first coverage identifier and the first claimant identifier, wherein the first claimant identifier is associated with the claimant master record; and
upon determining that the calculated string difference between the first claimant identifier and the first coverage identifier is below a minimum threshold, determine that the at least one first coverage record specifies that the claimant master record associated with the first claimant identifier is entitled to the supplemental claim at the time of the incurred date.

3. The computing system of claim 1, wherein the joint schema includes removal of one or more of extraneous characters, unnecessary characters or redundant characters in the plurality of claim records and the plurality of coverage records.

4. The computing system of claim 1, wherein the joint schema includes removal of characters in the plurality of claim records and the plurality of coverage records that are unnecessary for the computing system to interpret the plurality of claim records and the plurality of coverage records.

5. The computing system of claim 1, wherein the joint schema includes removal of redundant alphanumeric values from the plurality of claim records and the plurality of coverage records.

6. The computing system of claim 1, wherein the joint schema includes conversion of the plurality of claim records and the plurality of coverage records into an integer format.

7. The computing system of claim 1, wherein the joint schema includes conversion of the plurality of claim records and the plurality of coverage records into hash values.

8. At least one computer readable storage medium comprising a set of instructions, which when executed by a computing device, cause the computing device to:
identify a plurality of claim records that are associated with first heterogeneous data schemas;
identify a plurality of coverage records that are associated with second heterogeneous data schemas, wherein the second heterogeneous data schemas are at least partially distinct from the first heterogeneous data schemas, further wherein at least part of the first heterogeneous data schemas and the second heterogeneous data schemas are associated with a human-readable format;
transform, with a joint schema, the plurality of claim records from the first heterogeneous data schemas and the plurality of coverage records from the second heterogeneous data schemas to a homogeneous data schema to generate transformed claim records and transformed coverage records, wherein the homogeneous data schema is associated with a machine-readable format;
identify a qualifying claim from a first transformed claim record of the transformed claim records, wherein the first transformed claim record has an incurred date;
predict that the qualifying claim results in a supplemental claim by scanning the transformed coverage records and determining that at least one first coverage record of the transformed coverage records specifies that a claimant master record associated with the first transformed claim record is entitled to a supplemental claim at a time of the incurred date;
integrate the first transformed claim record and the at least one first coverage record to identify supplemental claim attributes; and
define a supplemental claim record based on the supplemental claim attributes.

9. The at least one computer readable storage medium of claim 8, wherein the instructions, when executed, cause the computing device to:
receive a first coverage identifier of the at least one first coverage record;
calculate a string difference between a first claimant identifier of the qualifying claim and the first coverage identifier based on a number of substitutions and deletions that are needed to transform one of the first claimant identifier and the first coverage identifier into the other of the first claimant identifier and the first coverage identifier, wherein the string difference provides a number indicating a distance between the first coverage identifier and the first claimant identifier, wherein the first claimant identifier is associated with the claimant master record; and
upon determining that the calculated string difference between the first claimant identifier and the first coverage identifier is below a minimum threshold, determine that the at least one first coverage record specifies that the claimant master record associated with the first claimant identifier is entitled to the supplemental claim at the time of the incurred date.

10. The at least one computer readable storage medium of claim 8, wherein the joint schema includes removal of one or more of extraneous characters, unnecessary characters or redundant characters in the plurality of claim records and the plurality of coverage records.

11. The at least one computer readable storage medium of claim 8, wherein the joint schema includes removal of characters in the plurality of claim records and the plurality of coverage records that are unnecessary for the computing device to interpret the plurality of claim records and the plurality of coverage records.

12. The at least one computer readable storage medium of claim 8, wherein the joint schema includes removal of redundant alphanumeric values from the plurality of claim records and the plurality of coverage records.

13. The at least one computer readable storage medium of claim 8, wherein the joint schema includes conversion of the plurality of claim records and the plurality of coverage records into an integer format.

14. The at least one computer readable storage medium of claim 8, wherein the joint schema includes conversion of the plurality of claim records and the plurality of coverage records into hash values.

15. A method executed with a computing system, the method comprising:
identifying a plurality of claim records that are associated with first heterogeneous data schemas;
identifying a plurality of coverage records that are associated with second heterogeneous data schemas, wherein the second heterogeneous data schemas are at least partially distinct from the first heterogeneous data schemas, further wherein at least part of the first heterogeneous data schemas and the second heterogeneous data schemas are associated with a human-readable format;
transforming, with a joint schema, the plurality of claim records from the first heterogeneous data schemas and the plurality of coverage records from the second heterogeneous data schemas to a homogeneous data schema to generate transformed claim records and transformed coverage records, wherein the homogeneous data schema is associated with a machine-readable format;
identifying a qualifying claim from a first transformed claim record of the transformed claim records, wherein the first transformed claim record has an incurred date;
predicting that the qualifying claim results in a supplemental claim by scanning the transformed coverage records and determining that at least one first coverage record of the transformed coverage records specifies that a claimant master record associated with the first transformed claim record is entitled to a supplemental claim at a time of the incurred date;
integrating the first transformed claim record and the at least one first coverage record to identify supplemental claim attributes; and
defining a supplemental claim record based on the supplemental claim attributes.

16. The method of claim 15, further comprising:
receiving a first coverage identifier of the at least one first coverage record;
calculating a string difference between a first claimant identifier of the qualifying claim and the first coverage identifier based on a number of substitutions and deletions that are needed to transform one of the first claimant identifier and the first coverage identifier into the other of the first claimant identifier and the first coverage identifier, wherein the string difference provides a number indicating a distance between the first coverage identifier and the first claimant identifier, wherein the first claimant identifier is associated with the claimant master record; and
upon determining that the calculated string difference between the first claimant identifier and the first coverage identifier is below a minimum threshold, determining that the at least one first coverage record specifies that the claimant master record associated with the first claimant identifier is entitled to the supplemental claim at the time of the incurred date.

17. The method of claim 15, wherein the joint schema includes removing one or more of extraneous characters, unnecessary characters or redundant characters in the plurality of claim records and the plurality of coverage records.

18. The method of claim 15, wherein the joint schema includes removing characters in the plurality of claim records and the plurality of coverage records that are unnecessary for the computing system to interpret the plurality of claim records and the plurality of coverage records.

19. The method of claim 15, wherein the joint schema includes removing redundant alphanumeric values from the plurality of claim records and the plurality of coverage records.

20. The method of claim 15, wherein the joint schema includes:
converting of the plurality of claim records and the plurality of coverage records into an integer format; and
converting of the plurality of claim records and the plurality of coverage records into hash values.

21. At least one computer readable storage medium comprising a set of instructions, which when executed by a computing device, cause the computing device to:
identify a plurality of claim records that are associated with first heterogeneous data schemas;
identify a plurality of coverage records that are associated with second heterogeneous data schemas, wherein the second heterogeneous data schemas are at least partially distinct from the first heterogeneous data schemas, further wherein at least part of the first heterogeneous data schemas and the second heterogeneous data schemas are associated with a human-readable format;
transform, with a joint schema, the plurality of claim records from the first heterogeneous data schemas and the plurality of coverage records from the second heterogeneous data schemas to a homogeneous data schema to generate transformed claim records and transformed coverage records by:
removing one or more of extraneous characters, unnecessary characters or redundant characters in the plurality of claim records and the plurality of coverage records, and
converting the plurality of claim records and the plurality of coverage records, that have the one or more of the extraneous characters, the unnecessary characters or the redundant characters removed, into hash values, wherein the homogeneous data schema is associated with a machine-readable format;
identify a qualifying claim from a first transformed claim record of the transformed claim records, wherein the first transformed claim record has an incurred date;
predict that the qualifying claim results in a supplemental claim by scanning the transformed coverage records and determining that at least one first coverage record of the transformed coverage records specifies that a claimant master record associated with the first transformed claim record is entitled to a supplemental claim at a time of the incurred date;
integrate the first transformed claim record and the at least one first coverage record to identify supplemental claim attributes; and
define a supplemental claim record based on the supplemental claim attributes.
